(19) United States
(12) Patent Application Publication
(10) Pub. No.: US 2009/0082443 A1
(43) Pub. Date: Mar. 26, 2009

(54) Use of fatty acid esters of glycerol combined with polylysine against gram-negative bacteria

(75) Inventors: Roel Otto, Gorinchem (NL); Aldana Mariel Ramirez, Wageningen (NL); Diderik Reinder Kremer, Groningen (NL)

Correspondence Address: OLIFF & BERRIDGE, PLC, P.O. BOX 320850, ALEXANDRIA, VA, 22320-4850, US

(73) Assignee: PURAC BIOCHEM B.V., GORINCHEM (NL)

(21) Appl. No.: 12/232,442

(22) Filed: Sep. 17, 2008

Related U.S. Application Data
(60) Provisional application No. 60/960,132, filed on Sep. 17, 2007.

(51) Int. Cl. A01N 37/00; A01P 1/00

(52) U.S. Cl. 514/546

(57) ABSTRACT

The present invention relates to a method for the prevention and/or reduction of the presence, growth and/or activity of gram-negative bacteria comprising application of a composition comprising glycerol-based fatty acid esters and polylysine and/or salts of polylysine, wherein said glycerol-based fatty acid ester is used as antibacterial agent. The present invention further relates to the use of said composition as antibacterial agent in various products and applications ranging from technical products and personal-care products to food and drink products for animals and human consumption.

The present invention relates to a method for reduction and/or prevention of the activity of gram-negative bacteria in or on products by using a composition based on fatty acid esters of glycerol. The present invention further is directed to the products resulting from using this method.

Fatty acid monoesters of glycerol are known for their antibacterial activity against yeasts, fungi and food-spoilage bacteria. They also have antibacterial activity against certain gram-positive food pathogenic bacteria such as for example Listeria and Clostridium. They are on themselves however not or hardly effective against gram-negative bacteria.

US 2005/0084471 describes the use of enhancers to make glycerol monoesters active against gram-negative bacteria such as Escherichia coli. The patent application provides an extensive list of all possible enhancers. The enhancer may be: an α-hydroxy acid, a β-hydroxy acid, other carboxylic acids, a chelating agent other than a carboxylic acid, a phenolic compound (e.g. certain antioxidants and parabens) or a C1-C10-monohydroxy alcohol. Further suitable enhancers are compounds highly specific for binding ferrous and/or ferric ion such as siderophores (e.g. enterobactin, pyochelin) and iron binding proteins (e.g. lactoferrin, transferring. Also included are chelators such as bacteriocins, antibacterial enzymes, sugars, sugar alcohol and combinations thereof. Above-mentioned chelating agent is described to be an organic compound capable of multiple coordination sites with a metal ion in solution. Typically these chelating agents are polyanionic compounds and coordinate best with polyvalent metal ions. Examples are ethylene diamine tetraacetic acid (EDTA) and salts thereof, various phosphate-based and/or phosphonic acid-based compounds, adipic acid, succinic acid, diethylenetriaminepenta-acetic acid, 1-hydroxyethylene and certain carboxylic acids such as α- and β-hydroxy acids, malic acid and tartaric acid.

The present invention provides a totally different means to enhance the antibacterial activity of fatty acid esters of glycerol against gram-negative bacteria. The present invention results in a very effective means against gram-negative bacteria, which may be applied in a wide-variety of products and applications ranging from technical products and applications to products for consumption and/or personal care. Hereto, the present invention is directed to a method for reduction and/or prevention of the activity, growth and/or presence of gram-negative bacteria in a product or on a surface comprising contacting said product or surface with a composition comprising a combination of a) fatty acid ester of glycerol and b) polylysine and/or a salt of polylysine, wherein said fatty acid ester of glycerol is applied as antibacterial or antimicrobial agent and not as emulsifier.

Fatty acid esters of glycerol are usually applied as emulsifiers but it has now been surprisingly found that they may be applied as antibacterial agent against specifically gram-negative bacteria as well by using them in a composition comprising polylysine and/or a salt hereof.

It is found that the combination of polylysine and/or salt with fatty acid esters of glycerol is capable of not simply enhancing the activity of both components whereby said enhancing effect is the sum of the individual activities of both the polylysine and the glycerol fatty acid ester, but it unexpectedly demonstrates a synergistic effect on the antibacterial activity as both components works in synergy resulting in an antibacterial activity which is significantly higher than the sum of the activities of the individual components of the composition.

Many of the enhancers mentioned in above prior art do not show this synergy and are not as synergistically effective in combination with the glycerol fatty acid monoesters as is the combination of fatty acid ester of glycerol and polylysine and/or a salt hereof according to the present invention.

Further, many of said enhancers are themselves not very effective against gram-negative bacteria and thus have to be applied in high quantities to show any enhancing antibacterial effect. In the quantities needed to achieve this antibacterial effect, said enhancers negatively affect the quality of the food product in which they are applied in terms of taste, color, odor and/or texture.

Organic acids for example are not that effective by themselves against gram-negative bacteria and in order to have an enhancing effect, a considerable amount of the organic acid is needed. The acid however negatively affects taste, texture and other properties of many products as they lower the pH of said food product in the quantity necessary to have any antibacterial effect. Acids are for example known to negatively affect the texture of protein-rich products (e.g. meat products) because they lead to for example the denaturation of the proteins.

An other example are the in prior art-mentioned proteins, siderophores and bacteriocins which are limited in their use because they are very sensitive to pH-changes in the food product or because they have an undesired affect on taste and texture of the food product.

This is also the case with many of the C1-C10-monohydroxy alcohols as mentioned in prior art, which have the disadvantage that they have a strong and undesired odor profile which make them unsuited for many applications in food and drink products.

The fatty acid esters of glycerol used in the method according to the present invention are also not very effective on their own against gram-negative bacteria, but in combination with polylysine and/or a salt hereof, a synergistically increased antibacterial activity is obtained at concentrations of the glycerol fatty acid esters that are acceptable in many food and drink products.

Polylysine is known to exert an antibacterial activity against gram-negative bacteria. Both α-polylysine and ε-polylysine have antibacterial activity although the latter one in significant greater extent as described by Shima et al. (November 1984). As described in the article, ε-polylysine can effectively be used against gram-positive and -negative bacteria in concentrations of about 1˜8 microgram per ml.

Hiraki et al. (2000) describe that when ε-polylysine is used together with antibacterial agents such as glycine, acetic acid (in the form of vinegar), ethanol or thiamine laurylsulfonate, its antibacterial efficiency is greatly enhanced. No mention is however made of a method wherein fatty acid esters of glycerol are combined with ε-polylysine in order to achieve an antibacterial activity against gram-negative bacteria, probably due to the very known poor activity of glycerol fatty acid esters against this type of gram-negative bacteria.

JP 2000-270821, JP 7-135943, JP 4-8273, JP 2001-587465, JP 2001-094794, JP 1999-321013, JP 11113779, JP 1994-298780, JP 2001-384674 describe compositions comprising ε-polylysine in combination with mono- and di-glycerol esters and other antibacterial components such as protamines, ethanol, glycine, lysozyme etceteras. Above-mentioned compositions are described to be effective against spore-forming and lactic acid-producing bacteria, against putrefactive bacteria such as Leuconostoc (Gram-positive) and against yeasts and fungi such as Candida.

Prior art, including above-mentioned patent literature, does not describe that fatty acid esters of glycerol combined with polylysine and/or a salt hereof can very effectively be applied against gram-negative bacteria and in particular against Escherichia coli, Salmonella, Campylobacter and Pseudomonas.

Further, prior art is directed to the use of fatty acid esters of glycerol as emulsifier or surfactant such as e.g. in JP 2002-274742 in blends that may comprise antibacterial agents such as polylysine and others. No prior art has been found to describe that fatty acid esters of glycerol have been used as antibacterial agent against gram-negative bacteria in a composition comprising polylysine and/or a salt hereof. Prior art does not describe that fatty acid esters of glycerol may be used to synergistically increase the antimicrobial effect of polylysine and/or any salt hereof.

The present invention thus comprises a method for reduction or prevention of the presence, growth and/or activity of gram-negative bacteria comprising contacting said bacteria with a composition comprising a combination of a) fatty acid ester of fatty acid and glycerol and b) polylysine and/or a salt hereof, wherein said fatty acid ester of fatty acid and glycerol is used as antibacterial agent.

Polylysine may be present as ε-polylysine, as α-polylysine or as a mixture hereof. ε-Polylysine is preferred as it has a higher antibacterial activity against gram-negative bacteria compared to the other forms of polylysine and thus lesser amounts of this antibacterial agent are needed to achieve a satisfactory synergy in the antibacterial activity against gram-negative bacteria in the applications. Further, ε-polylysine preferably comprises 30 to 50 L-lysine monomers linked by the peptide bonds between the free carboxyl groups and the e-amino groups. The fatty acid esters of the present invention may also be combined with one or more salts of polylysine.

The glycerol fatty acid ester of the present invention, also referred to as glyceride or glycerol or glycerol-based fatty acid ester, may comprise a monoester, a di-ester or a tri-ester of glycerol or mixtures hereof. The way in which these esters are produced often lead to mixture of the various mono-, di and/or tri-esters possible as commonly known. The esters can be separated from these mixtures by different techniques known by the person skilled in the art. Thus, when reference is made to mono-esters, these mono-esters of glycerol comprise the pure components as well as mixtures which mainly comprise mono-esters but also comprise di- and tri-esters as further components of said mixture.

Very good results were obtained when bacteria or products and surfaces containing said bacteria were contacted with a composition comprising a combination of polylysine with the mono- and di-esters of glycerol. High synergy leading to high antibacterial activities are observed with a composition comprising polylysine and/or a salt hereof combined with fatty acid ester of glycerol and fatty acid wherein said fatty acid comprises saturated fatty acid such as for example and not limited to hexanoic (C6) acid, octanoic (C8) acid, decanoic (C10) acid, dodecanoic (C12) acid, tetradecanoic (C14) acid, hexadecanoic (C16) acid, octadecanoic (C18) acid, and mixtures hereof.

When referral is made in this application to for example C8-glyceride or C10-glyceride, then meant are the fatty acid ester of glycerol and respectively octanoic acid and decanoic acid.

It was found that the method according to the present invention is even more effective if the bacteria or the product or surface containing the bacteria is contacted with a composition comprising glycerol fatty acid ester, polylysine and/or a salt thereof and further one or more lactylates. Lactylates are fatty acid esters of lactic acid (and/or the salt of lactic acid) and are well-known to the person skilled in the art. These components are known for their emulsifying effects and are accordingly used as emulsifiers. Both monolactylates and dilactylates are suitable as are mixtures hereof. The lactylate components are often obtained as mixtures of for example a mixture of predominantly monolactylates and further comprising dilactylates due to the way in which they are prepared. It may be very well possible that also higher polymerized lactylates are present in the mixture. The lactylates may be obtained in their pure form (e.g. only the mono-form) by means of for example chromatographic separation or by any other means known to the person skilled in the art.

The antibacterial composition used in the method according to the present invention further may comprise one or more organic acids and/or their salts or esters as these components further enhance the antibacterial activity. Preferably one or more organic acids and/or their salts or esters selected from lactic acid, acetic acid, citric acid, malic acid, fumaric acid, tartaric acid, gluconic acid, propionic acid and caproic acid are used because these acids do not have a negative impact on the product quality with respect to for example taste, odor and color of the product.

Optionally, the antibacterial composition used in the method according to the present invention further comprises one or more metal-chelating agents. The chelating agent may be selected from for example ethylene diamine tetraacetic acid (EDTA) and salts thereof, diethylenetriaminepenta-acetic acid and salts thereof, various phosphate-based compounds such as sodium hexametaphosphate, sodium acid pyrophosphate, and polyphosphoric acid, organophosphonate chelating compounds such as: phytic acid, 1,1-diphosphonic acid, siderophores and iron binding proteins such as enterobacterin and lactoferrin, and carboxylic acids and hydroxy carboxylic acids and/or salts thereof such as for example and not limited to succinic acid, ascorbic acid, glycolic acid, benzoic acid, octanoic acid and adipic acid.

It was found that the method according to the present invention is very effective against gram-negative bacteria of the family of Escherichia (e.g. Escherichia coli), Salmonella (e.g. Salmonella spp), Campylobacter (e.g. Campylobacter spp) and Pseudomonas (e.g. Pseudomonas spp) as the polylysine-components and glyceride-components in the composition act synergistically upon these specific target organisms whereby an antibacterial activity is achieved that is sufficient to prevent and/or reduce the presence, growth and/or activity of these gram-negative bacteria.

Further, the method according to the present invention is applicable in a great variety of products and applications, ranging from for example products of low and high pH-values, highly concentrated and diluted products, products usable in the technical field (e.g. in detergents for industrial or house-hold use), in the pharmaceutical field (e.g. for cleaning/disinfection of equipment or in the preparation of pharmaceutical compositions or their packaging), in personal care (e.g. in manufacture of cosmetics, shampoos, creams and lotions), in the feed industry (e.g. for cleaning of equipment, in the manufacture, storage, handling and preparation of animal feed and drink products) and in the food and drink industry.

The present invention therefore relates to the use of a glycerol fatty acid ester as antibacterial agent against gram-negative bacteria in a composition comprising polylysine and/or a salt hereof for the reduction and/or prevention of the presence, growth or activity of gram-negative bacteria, and in particular the bacteria mentioned earlier, in the manufacture, handling, storage and preparation of detergents, of cosmetic products and of personal-care products.

Hereto, the method according to the present invention for reduction or prevention of the presence, growth or activity of gram-negative bacteria in detergent-products, cosmetic products and personal-care products comprises contacting said products with a composition comprising glycerol fatty acid ester and polylysine and/or a salt hereof according to the various embodiments of the present invention during one or more stages of manufacture, handling, storage or preparation of said products, wherein said glycerol fatty acid ester is used as antibacterial agent.

A composition comprising glycerol fatty acid ester and polylysine and/or a salt is further found to be very usable for cleaning surfaces. The method according to the present invention therefore also is directed to reduction or prevention of the presence, growth or activity of gram-negative bacteria on a surface, and in particular the bacteria mentioned earlier, comprising contacting said surface with an antibacterial composition comprising glycerol fatty acid ester and polylysine and/or a salt hereof, wherein said glycerol fatty acid ester is used as antibacterial agent.

The present invention further is directed to the use of glycerol fatty acid ester as antibacterial agent against gram-negative bacteria in a composition comprising polylysine and/or a salt hereof in the manufacture, handling, storage and preparation of food and drink products for the feed industry and of food and drink products for human consumption.

Hereto, the method according to the present invention for reduction or prevention of the presence, growth or activity of gram-negative bacteria in food and drink products for animals or human consumption comprises contacting said products with a composition comprising glycerol fatty acid ester and polylysine and/or a salt hereof during one or more stages of the food processing process such as in the manufacture, handling, storage or preparation of said products, wherein said glycerol fatty acid ester is being applied as antibacterial agent.

Examples of food and drink products are beverages such as for example carbonated and non-carbonated beverages and fruit or vegetable-based juices, protein-rich products such as for example various meat and fish products, dressings, sauces and toppings, ready-to-eat and ready-to-drink products, refrigerated and high temperature-treated products etceteras. These products can be very well manufactured or treated with the method according to the present invention. The resulting products are not negatively affected in organoleptic quality in terms of e.g. taste, texture and color while the products are being protected against food spoilage and/or food poisoning by the presence and activity of gram-negative bacteria.

Glycerol fatty acid esters will normally be present in a food or drink product in an amount of up to 5% by weight of the product, preferably from 0.0001% to 5%, preferably from 0.0001% to 2%, preferably from 0.0001% to 1%.

Polylysine will normally be present in a food or drink product in an amount of up to 1% by weight of the product, preferably from 0.0001% to 1%, preferably from 0.0001% to 0.1%, preferably from 0.0001% to 0.01%, preferably from 0.0001% to 0.001%.

EDTA, organophosphates and polyphosphates will normally be present in a food or drink product in an amount of up to 1% by weight of the product, preferably from 0.0001% to 1%.

Lactylate will normally be present in a food or drink product in an amount of up to 1% by weight of the product, preferably from 0.0001% to 1%, or even from 0.0001% to 0.1% and most preferably from 0.0001% to 0.01%.

Organic acids such as for example lactic acid, fumaric acid, succinic acid, tartaric acid, ascorbic acid, glycolic acid, benzoic acid, acetic acid, propionic acid, octanoic acid, malic acid and adipic may be present in a food or drink product in an amount of up to 10% by weight of the product, preferably from 0.0001% to 10%, preferably from 0.0001% to 5%.

In the method according to the present invention, the above-mentioned food and drink products are contacted with the composition of the present invention comprising glycerol fatty acid ester and polylysine and/or a salt hereof. In a preferred embodiment of the method according to the present invention, the food and drink products are injected with the above-mentioned composition. The composition is then present in the interior part or inside the product.

In an other preferred embodiment of the present invention, the method comprises surface-treating the products with the composition comprising glycerol fatty acid ester and polylysine and/or a salt hereof. This may be done not only in the final product stage but also during or in for example the disinfection of carcasses in the manufacture of meat products or in the washing step applied for fruit and vegetables. The antibacterial composition may be brought in contact with or introduced into the product to be treated by various means such as for example as a spray, a rinse or a wash solution or as solution wherein the various food products are dipped.

Dependent on the type of application and on whether the composition of the present invention is used as active ingredient in the final product or as component of for example a wash solution or spray, the components of the composition will vary in concentration and in internal ratio as will be obvious to the person skilled in the art.

The composition comprising glycerol fatty acid and polylysine and/or a salt hereof may be available in solid or liquid form. If the composition is in liquid form, it generally is in the form of an aqueous composition, which may be a solution or a dispersion. Such an aqueous composition generally comprises, based on total weight of the solution, from 0.0001 wt % to up to 40 wt %, more preferably from 0.1 wt % to 35 wt %, and most preferably from 1 to 25 wt % of polylysine and from 0.0001 wt % up to 45 wt. %, more preferably from 1 to 40 wt %, and most preferably from 5 to 35 wt % of a glycerol fatty acid ester according to the present invention. The composition may further comprise a lactylate in an amount of 0 to 45 wt % and more preferably from 5 to 35 wt % and further an organic acid in the range of 0 to 45 wt % and more preferably from 0 to 30 wt %.

The glycerol fatty acid ester and the polylysine or the salt thereof may be introduced in the liquid composition by means of carriers. The person skilled in the art knows what type of carriers can be used. Among various well-known carriers, it was found that polyethylene glycol and/or lactate function very well as carrier. The carrier may be present in concentrations of about 50 to 98 wt %. Further, various emulsifiers known to the person skilled in the art may be added. Preferably emulsifiers such as polysorbates (e.g. polysorbate 60 or 80) and lecithin are applied in concentrations of for example 0.1 to 25%, more preferably 1-10% and most preferably 2 to 4% based on 100% fatty acid derivative, such as glycerol fatty acid ester and/or lactylate, if the latter component is used in the composition in addition to glycerol fatty acid ester and polylysine or a salt thereof.

If the composition comprising glycerol fatty acid ester and polylysine or the salt thereof is in solid form, it will generally be in the form of a powder comprising particles of the relevant components. The composition in solid form generally comprises, based on total weight of the powder, from 0.0001 wt % to up to 40 wt %, more preferably from 0.1 wt % to 35 wt %, and most preferably from 1 to 25 wt % of polylysine and from 0.0001 wt % up to 45 wt. %, more preferably from 1 to 40 wt %, and most preferably from 5 to 35 wt % of a glycerol fatty acid ester according to the present invention.

Use may be made of carriers. Very suitable carriers are silica and/or maltodextrin, which are present in concentrations up to 50 to 98 wt %.

The composition may further comprise a lactylate in an amount of 0 to 45 wt % and more preferably from 0 to 35 wt % and further an organic acid in the range of 0 to 45 wt % and more preferably from 0 to 30 wt %.

The following non-limiting examples further illustrate the present invention.

### EXAMPLE 1

The following cultures were used in a study: Escherichia coli (ATCC 8739), Escherichia coli serotype O157:H7 (ATCC 700728), Salmonella typhimurium (ATCC 13311) and Salmonella entiritidis (ATCC 13076). All cultures were transferred daily in screw-capped tubes containing 10 ml brain heart infusion broth. Cultures were incubated at 30° C. without agitation. Brain heart infusion broth was prepared with increasing amounts of the mono/di glyceride and polylysine. The concentration range for the caprylic (C8) mono/di glyceride was as from 0 to 0.18% in 10 0.02% steps, for the capric (C10) mono/di glyceride was as from 0 to 0.09% in 10 0.01% steps, for the lauric (C12)mono/di glyceride was as from 0 to 0.009% in 10 0.001% steps. Mono/di glycerides were combined with polylysine. The concentration range for the polylysine was as from 0 to 0.0675% in 10 0.0075% steps, resulting in 100 different media. The pH of the media was adjusted to 6.1-6.2 with 1 N HCl or 1 N NaOH. Media were prepared in 10 ml quantities and sterilized by filtration. 300 μl of each medium was transferred to a panel of a sterile Bioscreen® honeycomb 100 well plate. Well plates were inoculated with 5 μl of a culture that was grown overnight in brain heart infusion broth using a sterile 5 μl repeating dispenser. Growth rates were determined with a Bioscreen® that kinetically measures the development of turbidity by vertical photometry. The plates were incubated for 16-24 hours at 37° C., the optical density of the cultures was measured every 30 minutes at 420-580 nm using a wide band filter. The Bioscreen® measures at set time intervals the optical density of the cultures. From these data the Bioscreen® calculates maximum specific growth rates. The purpose of further data processing is to ascertain whether two amino acids act independently of each other or whether they stimulate each other in their inhibitory action (synergy) or cancel out each other inhibitory effect (antagonism). When a certain compound has no effect on an organism the specific growth rate of this organism (μ) can be expressed as a function (f) of the growth limiting substrate concentration (s) by for example the Monod equation, which reads: μ=μₘₐₓ.s/(Kₛ+s), where μₘₐₓ represents the maximum specific growth rate, s the standing concentration of the growth limiting substrate in the medium and Kₛ the substrate concentration where μ=0.5 μₘₐₓ However, when the presence of an inhibitor P affects cell growth the function f for μ must be modified i.e. μ=f(s,p), where p represents the concentration of inhibitor P. Numerous studies of growth inhibition kinetics of bacteria have shown that many inhibitors behave as non-competitive inhibitors. This implies that only the maximum specific growth rate (μₘₐₓ) value and not the affinity (Kₛ) is affected. Therefore the specific growth rate in the presence of inhibitor can be written as: μ=μᵢ.s/(Kₛ+s), where μᵢ is the maximal specific growth rate in the presence of a inhibitor P. The relationship between μᵢ and μₘₐₓ and the concentration of the inhibitor P was describes using the Logistic Dose Response equation, which reads: μᵢ/μₘₐₓ=1/(1+(p/P_{0.5})^{b}) (Jungbauer, A. (2001). The logistic dose response function: a robust fitting function for transition phenomena in life sciences. J. Clinical Ligand Assay 24: 270-274). In this equation p represents the concentration of inhibitor P and p_{0.5} the concentration of P where p=0.5 μₘₐₓ; μₘₐₓ is the maximum specific growth rate that is the specific growth rate in the absence of inhibitor P, b is a dimensionless quantity, which determines the relationship between μᵢ and p. Combining the Monod and Logistic Dose Response equation it can be written as: μ=μₘₐₓ (s/Kₛ+s)/(1+(p/p_{0.5})^{b}). In batch culture where s is usually many times higher than Kₛ this equation reduces to μ=μₘₐₓ/(1+(p/p_{0.5})^{b}). When comparing different organisms grown under the same conditions, or the same organism grown under different conditions, it is more meaningful to use relative growth rate, rather than absolute growth rates as standards of comparison. Relative growth rate (O) is the ratio of growth rate (μ) to maximum growth rate (μₘₐₓ) i.e. O=μ/μₘₐₓ. It can be seen that while μ and μₘₐₓ have the dimensions of (time)⁻¹, their ratio O is dimensionless, i.e. a pure number. Similarly we can define the relative inhibitor concentration ε as p/p_{0.5}. The reduced Monod and Logistic Dose Response equation can now be written as: O=1/(1+ε^{b}). For two inhibitors X and Y e.g. the following two expressions for O can be defined: Oₓ=1/(1+ε^{b1}) and O_{y}=1/(1+ε^{b2}). Oₓ and O_{y} can be experimentally evaluated by examining the inhibitory effects of either X or Y on the growth rate of the target organism. Knowing the evaluated functions for Oₓ and O_{y} the theoretical independent effect is defined as: Oₓ.O_{y}. The experimentally observed effect of combinations of X and Y on the relative growth rate is defined as O_{xy}. The hypothesis that X and Y act independently of each other on a certain organism mathematically translates to O_{xy}/Oₓ.O_{y}=1. Rejection of this hypothesis implies that the combined effect of X and Y is not an independent effect but either synergistic or antagonistic. In case the inhibitors X and Y act synergistically upon the target organism O_{xy}/Oₓ.O_{y}<1 (but>0). In those cases that the combined effect of inhibitors X and Y is antagonistic O_{xy}/Oₓ.O_{y}>1.

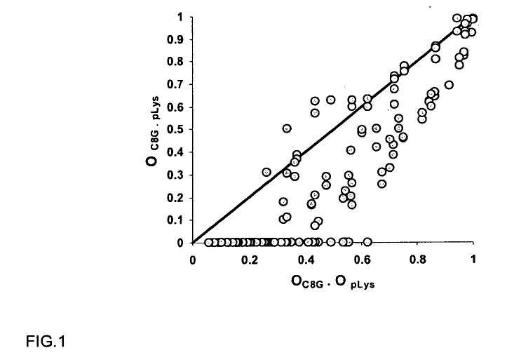

Synergy, independent effect, and antagonism can be visualized in a plot of O_{xy} versus Oₓ.O_{y}. This is exemplified in FIG. 1-4, wherein different plots are given of O_{CxG. pLys} (experimentally observed relative growth rate in the presence of mixtures of a monoglyceride and polylysine) versus O_{CxG}.O_{pLys} (predicted relative growth rate in the presence of mixtures of a lactylate and polylysine) for Salmonella typhimurium (ATCC 13311) and Salmonella entiritidis (ATCC 13076) showing the synergy in inhibition between lactylates and polylysine. The solid line in this graph represents the line where the experimentally observed relative growth rate (O_{CxL.pLys}) equals the predicted relative growth rate (O_{CxL}.O_{pLys}) and where the lactylate and polylysine act as independent inhibitors.

FIG. 1 represents a plot of experimentally observed relative growth rate of Salmonella typhimurium in the presence of mixtures of C8-glyceride and polylysine (O_{C8G. pLys}) versus predicted relative growth rate in the presence of mixtures of C8-glyceride and polylysine (O_{C8G}.O_{pLys}).

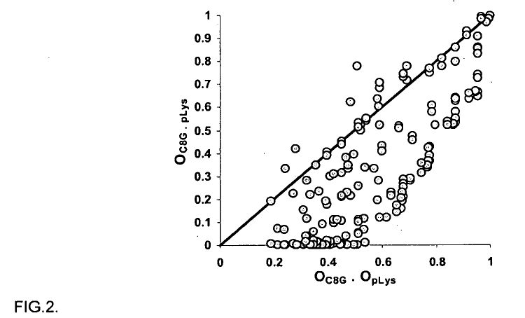

FIG. 2 represents a plot of experimentally observed relative growth rate of Salmonella entiritidis in the presence of mixtures of a C8-glyceride and polylysine (O_{C8G. pLys}) versus predicted relative growth rate in the presence of mixtures of C8-glyceride and polylysine (O_{C8G}.O_{pLys}).

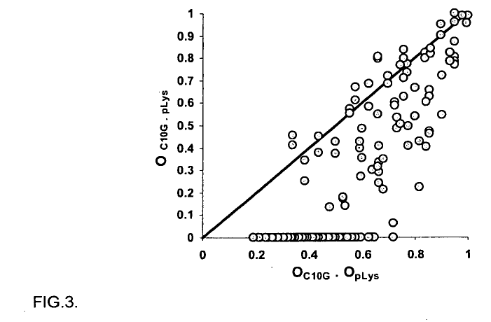

FIG. 3 represents a plot of experimentally observed relative growth rate of Salmonella typhimurium in the presence of mixtures of a C10-glyceride and polylysine (O_{C10G. pLys}) versus predicted relative growth rate in the presence of mixtures of C10-glyceride and polylysine (O_{C10G}.O_{pLys}).

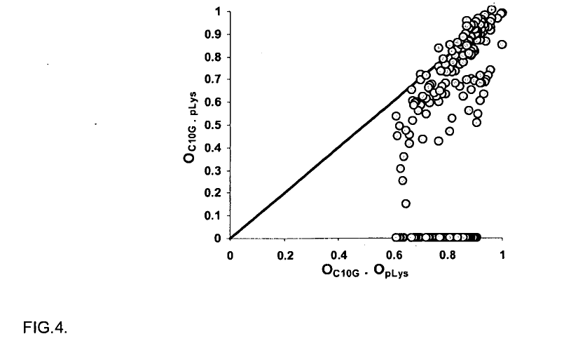

FIG. 4 represents a plot of experimentally observed relative growth rate of Salmonella entiritidis in the presence of mixtures of a C10-glyceride and polylysine (O_{C10G. pLys}) versus predicted relative growth rate in the presence of mixtures of C10-glyceride and polylysine (O_{C10G}.O_{pLys}).

FIGS. 1-4 demonstrate that polylysine and glycerides in the various combinations tested act synergistically upon the target organism as O_{xy}/Oₓ.O_{y}<1 and >0 (represented by the dots below the solid line).

Further examples of synergy are given in Table 1 such as for example the synergy between 0.0225% (w/w) polylysine and 0.12% (w/w) C8-glyceride or 0.0225% (w/w) polylysine and 0.09% (w/w) C10-glyceride. As can be observed in the Table, the relative growth rate of Escherichia coli (ATCC 8739), Escherichia coli serotype O157:H7 (ATCC 700728), Salmonella typhimurium (ATCC 13311) or Salmonella entiritidis (ATCC 13076) in a broth containing 0.0225% (w/w) polylysine and 0.12% (w/w) C8-glyceride or 0.0225% (w/w) polylysine and 0.09% (w/w) C10-glyceride is in all cases lower than can be expected on the basis of the relative growth rate of these organisms in media containing either polylysine or one of the glyceride esters.

TABLE 1
Examples of synergy

| | Observed Relative Growth Rate | | |
|---|---|---|---|
| | C8-glycerol | | C8-glycerol ester |
| compound | ester | polylysine | plus polylysine |
| Concentration (w/w) | 0.120% | 0.0225% | 0.12%/0.0225% |
| Escerichia coli ATCC 8739 | 1.0845 | 0.7570 | 0.0000 |
| E. coli O157:H7 ATCC 700728 | 0.9410 | 0.8315 | 0.0000 |
| Salmonella typhimurium ATCC 13311 | 0.4035 | 0.9653 | 0.0000 |
| S. enteritidis ATCC 13076 | 0.5220 | 0.9945 | 0.0730 |
| | Observed Relative Growth Rate | | |
| | C10-glycerol | | C10-glycerol ester |
| compound | ester | polylysine | plus polylysine |
| Concentration (w/w) | 0.090% | 0.0225% | 0.09%/0.0225% |
| Esherichia coli O157:H7 ATCC 700728 | 0.8685 | 0.5850 | 0.0000 |
| Salmonella typhimurium ATCC 13311 | 0.4613 | 0.9910 | 0.0000 |
| S. enteritidis ATCC 13076 | 0.8960 | 0.9600 | 0.0000 |

### EXAMPLE 2

### Antimicrobial Effect in Contaminated Chicken Filet and Milk

### Materials and Methods

Culture and Culturing Conditions

Salmonella Typhimurium ATCC 13311 and Escherichia coli O157:H7 ATCC 700728 were grown in sterile screw capped tubes containing Brain heart infusion broth for 18-24 hours at 30° C.

Preparation of Chicken Filets

Chicken filets (150-200 g) were trimmed, vacuum packaged and stored at 4-7° C. Filets were subsequently sterilized by gamma-irradiation (average radiation dose: 12 kiloGray).

Inoculation of Chicken Filets with Salmonella typhimurium.

1 ml of an overnight culture of Salmonella Typhimurium in brain heart infusion both was diluted 1000 times with sterile 0.8% (w/v) NaCl and 0.1% (w/v) peptone. 0.5 ml of this diluted culture was transferred to one side of the filet. The inoculum was distributed by gently rubbing the entire surface of the filet. This was repeated for the other side of the filet. Inoculation was carried out at 6° C. Inoculated filets were rested for 60-120 min at 6° C. to allow attachment of the cells.

Decontamination of Chicken Filets

Chicken filets were briefly dipped and completely submersed in 1 l of a solution containing the appropriate formulation and then transferred to 400 ml Bagfilter® lateral filter bags (Interscience, St Nom, France) containing 5 ml of the appropriate formulation. Bags were vacuum-sealed and incubated at 12° C. for up to 7 days until further analysis. Time zero samples were plated within 30 min after dipping.

Microbial analysis of chicken filets.

Surviving Salmonella Typhimurium on chicken filets were counted as follows: a sealed bag was opened and to this was added 2 times the net weight sterile dilution fluid (8.5% (w/v) NaCl and 0.1% (w/v) bacteriological peptone). Duplicate filets were homogenized for 1 min. in a Bagmixer® 400 paddle labblender (Interscience, St Nom, France). 50 μl of the homogenates or dilutions thereof were plated on duplicate Salmonella chromogenic agar plates (CM1007) with cefsulodin, novobiocin supplement (SR0194) (Oxoid, Basingstoke, United Kingdom) using an Eddyjet type 1.23 spiral plater (IUL Instruments, Barcelona, Spain). Plates were incubated for 24-48 hours at 30° C. and then counted. Salmonella numbers were expressed as log₁₀ colony forming units per ml homogenate.

Inoculation of Milk Treated with Antimicrobial Formulations

Sterile low fat milk was purchased fro a local supermarket and 100 ml quantities were transferred to a series of sterile screw topped bottles. ε-Polylysine, The sodium salt of glyceryl mono/di octanoate (C8 mono/di glyceride) and glyceryl mono/di decanoate (C10 mono/di glyceride) was added to a concentration as shown in Table 2. The different milk preparations were inoculated with an overnight culture of Escherichia coli O157:H7. The starting cell density was log₁₀ 2.5-3.0.

Microbial Analysis of Milk Cultures

Surviving Escherichia coli O157:H7 were counted as follows: duplicate 50 μl samples of milk cultures or dilutions thereof were plated on duplicate Violet Red Bile Glucose (VRBG) agar plates (CM0485 Oxoid, Basingstoke, United Kingdom) using an Eddyjet type 1.23 spiral plater (IUL Instruments, Barcelona, Spain). Plates were incubated for 24-48 hours at 30° C. and then counted. Escherichia coli numbers were expressed as log₁₀ colony forming units per ml homogenate.

Preparation of Antimicrobial Formulations

The compositions of the formulations that were studied are shown in Table 2. ε-Polylysine and mono/di glycerides were dissolved in demineralised water and sterilized for 20 min at 120° C.

TABLE 2
Composition of antimicrobial formulations

| Formulation | Blanc | 1 | 2 |
|---|---|---|---|
| ε-polylysine | | 0.1% (w/v) | 0.1% (w/v) |
| C8-mono/di- | | 0.2% (w/v) | |
| glyceride | | | |
| C10-mono/di- | | | 0.05% (w/v) |
| glyceride | | | |
| NaCl | 0.8% | 0.8% (w/v) | 0.8% (w/v) |
| | (w/v) | | |

Chemicals

ε-Polylysine was purchased from Chisso America Inc (New York, USA). The sodium salt of glyceryl mono/di octanoate (C8 mono/di glyceride) and glyceryl mono/di decanoate (C10 mono/di glyceride) were purchased from Caravan Ingredients (Lenexa, Kans., USA).

Results Decontamination of Chicken Filets

Exposure of Salmonella Typhimurium ATCC 13311 present on chicken filets to combinations of ε-polylysine with mono/di glycerides resulted in an almost immediate reduction of the number of viable cells by approximately 90% (Table 3). After one day at 12° C. the reduction in numbers is more than a 4 log₁₀. The suppression of growth by the tested combinations is not permanent; after 4 days the numbers have increased although after 7 days after incubation the difference between the formulations and the blanc is never less than 2 log₁₀ and microbial activity is still present.

TABLE 3
Effect of combinations of ε-polylysine (ε-PL) with mono/di
glycerides on Salmonella Typhimurium on chicken filets at 12° C.;
expressed in log₁₀ colony forming units (CFU)/ml

| | Formulation | | |
|---|---|---|---|
| | | 0.1% (w/v) ε-PL + | 0.1% (w/v) ε-PL + |
| | | 0.2% (w/v) | 0.05% (w/v) |
| Time | | C8-mono/di | C10-mono/di |
| (days) | Blanc | Glyceride | glyceride |
| 0 | 3.74 | 2.68 | 3.02 |
| 1 | 5.91 | 0 | 0 |
| 4 | 6.01 | 3.82 | 4.17 |
| 5 | 6.89 | 5.18 | 4.53 |
| 6 | 7.36 | 4.5 | 5.23 |
| 7 | 7.46 | 4.46 | 5.18 |

Individually the glycerol esters did not show any killing or growth suppressing effect in the absence of ε-polylysine (Table 4). ε-Polylysine itself reduced the cell numbers although the effect was less than if it was combined with one of the fatty acid derivatives. This was particularly clear after one day of incubation. Whereas the reduction in numbers for the combinations ranged from 4 log₁₀ to 5 log₁₀ (Table 3) the reduction for ε-polylysine as single addition was only 2 log₁₀ (Table 4). This suggests that there is a form of synergy in inhibition between ε-polylysine and the fatty acid derivatives. This is confirmed by in vitro studies in which the effects of these combinations were studied in broth (experiment 1).

TABLE 4
Individual effect of ε-polylysine and C8 and C10 mono/di
glycerides on Salmonella Typhimurium on chicken filets at
12° C.; expressed in log₁₀ colony forming units (CFU)/ml

Formulations

| | | | 0.2% (w/v) | 0.05% (w/v) |
|---|---|---|---|---|
| Time | | 0.1% (w/v) | C8-mono/di | C10-mono/di |
| (days) | Blanc | ε-polylysine | Glyceride | glyceride |
| 0 | 3.8 | 3.04 | 3.82 | 3.72 |
| 1 | 4.05 | 2.04 | 3.81 | 3.98 |
| 2 | 4.82 | 2.15 | 4.03 | 4.32 |
| 5 | 7.2 | 4.04 | 6.41 | 6.0 |
| 6 | 7.6 | 4.26 | 7.48 | 7.62 |
| 7 | 7.68 | 5.35 | 7.39 | 7.85 |

Results Inhibition of Escherichia coli O157:H7 in Milk

Strong inhibition of growth by combinations of ε-polylysine with mono/di glycerides was also observed for Escherichia coli O157:H7 growing in non fat milk (Table 5)

TABLE 5
Effect of combinations of ε-polylysine (ε-PL) with mono/di
glycerides on Escherichia coli O157:H7 in milk at 12° C.;
expressed in log₁₀ colony forming units (CFU)/ml

| | Formulations | | |
|---|---|---|---|
| | | 0.1% (w/v) ε-PL + | 0.1% (w/v) ε-PL + |
| | | 0.2% (w/v) | 0.05% (w/v) |
| Time | | C8-mono/di | C10-mono/di |
| (days) | Blanc | glyceride | glyceride |
| 0 | 2.85 | 2.6 | 2.7 |
| 1 | 3.48 | 1.3 | 1.85 |
| 2 | 6.12 | 1.0 | 2.71 |
| 3 | 7.42 | 1.0 | 3.8 |
| 6 | ND | 1.0 | 5.89 |

(ND: No data)

Contrary to the chicken filets no initial kill was observed. The combination of ε-polylysine with the C8 mono/di glyceride (glyceryl mono/di octanoate) was particularly effective.

1. Method for reduction or prevention of the activity, growth or presence of gram-negative bacteria in a product or on a surface comprising contacting said product or surface with a composition comprising a combination of
a. an ester of glycerol and fatty acid
with
b. polylysine or a salt of polylysine or a mixture hereof, wherein said ester of glycerol and fatty acid is used as antibacterial agent.

2. The method according to claim 1 wherein said fatty acid ester of glycerol is a mono- or di-ester of glycerol or a mixture hereof.

3. The method according to claim 1 wherein said fatty acid is selected from hexanoic acid, octanoic acid, decanoic acid, dodecanoic acid, tetradecanoic acid and mixtures hereof.

4. The method according to claim 1 wherein polylysine is ε-polylysine.

5. The method according to claim 1 wherein said composition further comprises one or more organic acids or a salt or ester hereof or a mixture hereof.

6. The method according to claim 1 wherein said composition further comprises one or more metal chelating agents.

7. The method according to claim 1 wherein said composition further comprises one or more lactylates.

8. The method according to claim 1 wherein said composition is in liquid or solid form and wherein the composition comprises from 0.0001 to 45 wt % of the ester of glycerol and fatty acid, 0.0001 to 40 wt % of polylysine or a salt hereof or a mixture hereof, 0 to 45 wt % of lactylate, 0 to 45 wt % of organic acid or a salt or ester or a mixture hereof, 0 to 98 wt % of a carrier and 0 to 20 wt % of an emulsifier.

9. The method according to claim 1 wherein said composition is contacted with bacteria from the family of Escherichia coli, Salmonella, Campylobacter or Pseudomonas.

10. The method according to claim 1 wherein the product is contacted with the composition during one or more stages of manufacturing, handling, storing or preparing the product.

11. The method according to claim 1 wherein the product is a food or drink product for human consumption, a feed or food product for animal consumption, a cleaning product, a detergent, a cosmetic product or a personal-care product.

12-14. (canceled)
